(19) United States
(12) Patent Application Publication
(10) Pub. No.: US 2012/0005956 A1
(43) Pub. Date: Jan. 12, 2012

(54) Portable plant bucket

(76) Inventor: Fred S. Whistle, Searcy, AR (US)

(21) Appl. No.: 13/134,859

(22) Filed: Jun. 21, 2011

Related U.S. Application Data
(60) Provisional application No. 61/398,894, filed on Jul. 6, 2010.

(51) Int. Cl. A01G 9/02

(52) U.S. Cl. 47/79

(57) ABSTRACT

A generally cylindrical planter in the form of an inverted, truncated cone includes a pail with an internal, perforated baffle that divides the interior into separate, laterally spaced apart volumes. A water level float indicator is mechanically secured by the baffle. An overfilling prevention orifice is defined in the peripheral surface of the pail overfilling with water. A smaller “weep” hole disposed beneath the overfill-preventing hole 20 is normally blocked by a removable plug that can be removed to establish a proper fill line. The generally planar baffle is disposed at an angle within the pail, intersecting the pail body to form a conic section. The baffle is angled at approximately forty to fifty degrees.

### CROSS REFERENCE TO RELATED INVENTION

This invention is based upon and claims priority from a previously filed U.S. Provisional Application entitled “Portable Plant Bucket,” Ser. No. 61/398,894, filed Jul. 6, 2010, buy inventor Fred Whistle.

### BACKGROUND OF THE INVENTION

I. Field of the Invention

The present invention relates generally to planters, buckets and pots for containing and growing live plants. More particularly, the present invention relates to growing pots with internal baffles or dividers that separate soil or mulch from adjacent water.

II. Description of the Prior Art

It has long been recognized by those skilled in the art that partitioned plant containers or pots lend certain advantages to plants by separating the main soil bearing sections from lower water reservoirs. A variety of prior art baffle or partition plate designs exist. However, all prior art designs known to me involve partitions or baffles that are disposed either horizontally or vertically within the usually cylindrical pot or container.

For example, U.S. Pat. Nos. 2,081,337 issued May 25, 1937 and 3,137,096 issued Jun. 16, 1964 disclose generally cylindrical plant containers using horizontally disposed, perforated baffles to separate water in a lower reservoir compartment from the soil (and plant root system) located above.

U.S. Pat. No. 3,576,088 issued Apr. 27, 1971 discloses a self watering plant receptacle holding water within its bottom. A perforated, soil support baffle separates the water from the soil above. Material extending from the baffle into the water forms a wick.

U.S. Pat. No. 3,683,548 issued Aug. 15, 1972 discloses a plant container using both vertical and horizontal partitions to separate different types of soil or plant growing media. One media is a coarse medium located at the bottom of the container below the horizontal partition. The other media is a fine medium located above the horizontal partition to the side of the vertical partition. A wick is extending from the coarse medium at the container bottom upwardly through the horizontal partition into the fine medium delivers moisture thereto.

U.S. Pat. No. 3,857,196 issued Dec. 31, 1974 and entitled “Moisture Saving Apparatus” discloses a generally cylindrical container having an opening covered with a convex cap that forms a baffle. The container is buried, and the ground above it contacts the cap. The cap is perforated, allowing water to seep into the container. Water can flow into the container through a sponge held in position beneath the cap by a screen extending across the opening of the container to prevent dirt from falling into the container. When the soil above the container is dry, the fluid within the container is transmitted by a wick extending through the cap, sponge, and screen between the dry earth and the fluid in the container.

U.S. Pat. No. 4,305,226 issued Dec. 15, 1981 shows a plant growth and care system with a plurality of wicks that distribute moisture. Perforated partition structure is disposed beneath the soil.

U.S. Pat. No. 4,527,354 issued Jul. 9, 1985 discloses a container for automatically watering plants. Water and plant nutrients are drawn by the capillary action of fibrous wicks, which contact the lower soil and extend through a reservoir through perforations. A float-operated indicator is provided for monitoring water level.

U.S. Pat. No. 5,644,868 issued Jul. 8, 1997 shows a plant container comprising a perforated partition, spaced apart from and extending across the container bottom. The partition divides the interior of the container into an upper compartment for soil and a lower compartment for water. Ventilation tubes extend upwardly from the partition so air can reach the lower compartment. Water absorbent bars passing through the partition wick water into the soil above the partition through capillary action.

U.S. Pat. No. 7,634,871 issued Dec. 22, 2009 discloses a growing container with a bottom, a surrounding wall, and a horizontal, perforated partition located in the container above the bottom. The partition is held a predetermined distance above the bottom. The partition separates dirt or soil from water.

None of the above teachings exhibits the enhanced aeration and plant stability characteristics achieved with my design that utilizes a unique angled partition plate.

### SUMMARY OF THE INVENTION

This invention provides an enhanced receptacle for holding and nurturing growing plants. A unique, angled baffle, in the form of a truncated ellipse, is disposed at an angle within the cylindrical container to divide the receptacle interior into a water reservoir and an adjacent soil region. These regions are separated at an angle, so that water may be wicked somewhat horizontally, and somewhat vertically, in a side by side manner, rather than exclusively vertically as in prior art designs. Efficiency of the receptacle, and thus plant health, are enhanced.

Thus, a basic object of my invention is to provide an enhanced plant pot for horticultural applications.

Another object of the invention is to stabilize the moisture content of a plant pot. It is a feature of the invention that ff the moisture content is too great, the pail will automatically drain to a fixed level.

A related object of my invention is to provide a plant pot for horticultural application with an enhanced baffle that increases water distribution, promotes root health, and plant growth.

Another basic object of my invention is to provide a plant pot for horticultural application in which plants can be easily grown.

A similar object is to provide an improved plant container that increases aeration.

Another object is to help stabilize moisture content within the plant root area.

A similar object is to maximize nutrient-feeding of plants.

It is also an advantage of the present invention that a grower may leave plants to indoor plants unattended for long periods of time. The invention may also be used in connection with large outdoor architectural planters and even for the growing of commercially valuable plants.

A still further object of my invention is to insure that necessary amounts of water and oxygen are supplied to the plant.

A further object of the present invention is to provide an improved plant growing pot that permits easy and proper care of a plant by the non-professional horticulturist.

It is still another object of the invention to provide a continuously operating apparatus, which requires little or no maintenance.

These and other objects and advantages of the present invention, along with features of novelty appurtenant thereto, will appear or become apparent in the course of the following descriptive sections.

### BRIEF DESCRIPTION OF THE DRAWINGS

In the following illustrations, which form a part of the specification and which are to be construed in conjunction therewith, and in which like reference numerals have been employed throughout wherever possible to indicate like parts in the various views:

FIG. 1 is a front elevational view of my new plant container;

FIG. 2 is a frontal isometric view thereof;

FIG. 3 is a top plan view thereof;

FIG. 4 is a fragmentary, longitudinal sectional view taken generally along line 4-4 of FIG. 2;

FIG. 5 is a top plan view of the preferred baffle; and,

FIG. 6 is a partially exploded view of the baffle and float assembly.

### DETAILED DESCRIPTION

Turning now to the appended drawings, the reference numeral 10 broadly designates an improved plant receptacle or pot constructed in accordance with the best mode of my invention known to me at this time. In the best mode pot 10 comprises a generally cylindrical pail 12, preferably made of plastic. Pot 10 can be made of ceramic materials, metal, plastic or the like. The pot geometry is not critical as long as there is an interior that fits the baffle construction described below. While preferably generally cylindrical, in the best mode it is in the form of an inverted, truncated cone, with a base 11 that has a smaller diameter than the diameter of its top 13. A conventional handle 14 is preferably included for carrying.

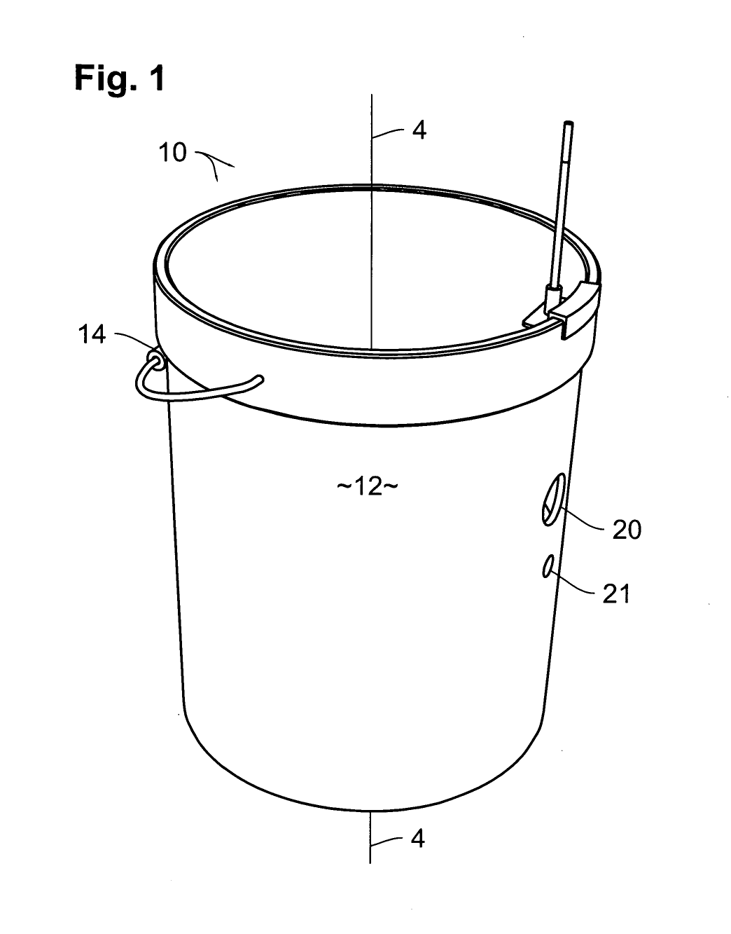

As best seen in FIGS. 1-4, the pail interior 16 includes a perforated baffle 15 that is inclined within the interior 16, and a water level float indicator 18. It is preferred that there is a small orifice 20 (FIG. 1) in the peripheral exterior surface 12A of the pail that penetrates the pail body and prevents overfilling with water. The overfill preventing orifice 20 is preferably 0.75 inches in diameter, but can be between 0.75 inches and 2.0 inches in diameter. This hole allows water to escape, as when the pail is disposed outside and faces heavy rain. Thus, the water level is maintained, over-watering is prevented, and the proper moisture is maintained. Also, the size of hole 20 allows a garden hose spray head or nozzle to enter the bucket, to clean the baffle plate and direct a spray directly on the baffle.

Preferably there is a smaller “weep” hole 21 disposed beneath overfill-preventing hole 20. Weep hole 21 is normally blocked by a removable plug 23 (FIG. 1). However, weep hole 21 can be opened by removing plug 23 to establish a proper fill line when the pail 10 is first filled with water. One can also view and establish a proper water level after the pail is filled with water, soil and plants. In this case, plug 23 is removed to open hole 21 while filling pail 10 with a garden hose, for example, that can spray water into the pail interior 16 through overfill preventing hole 20.

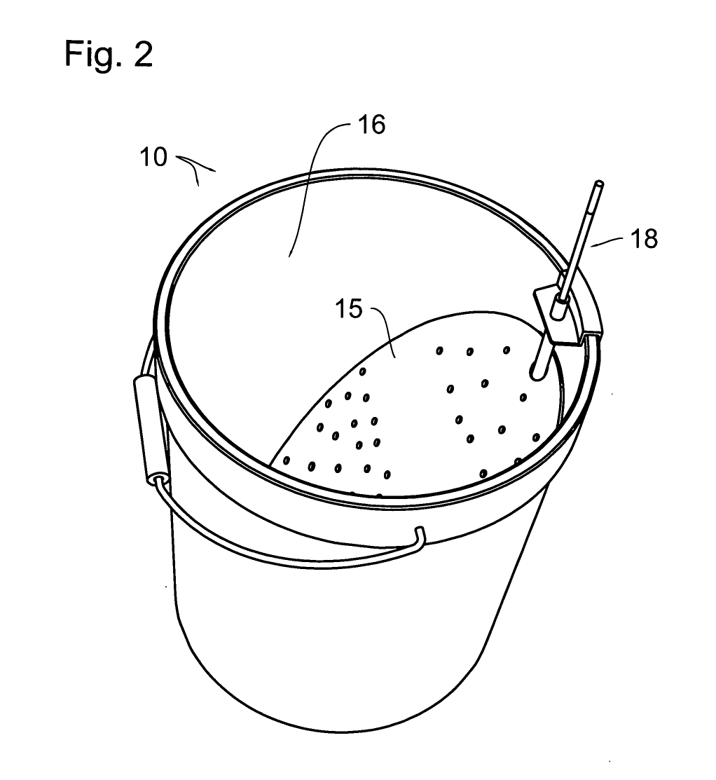

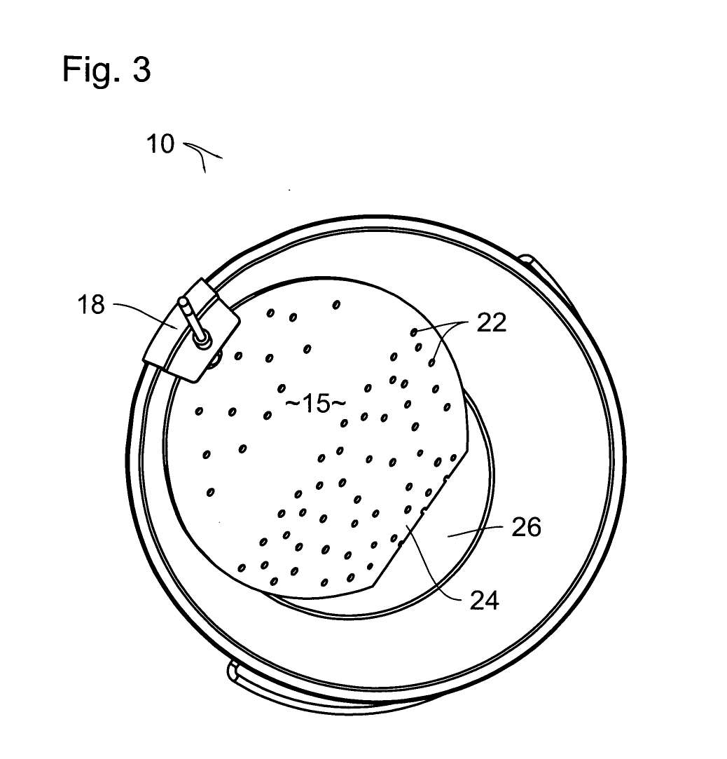

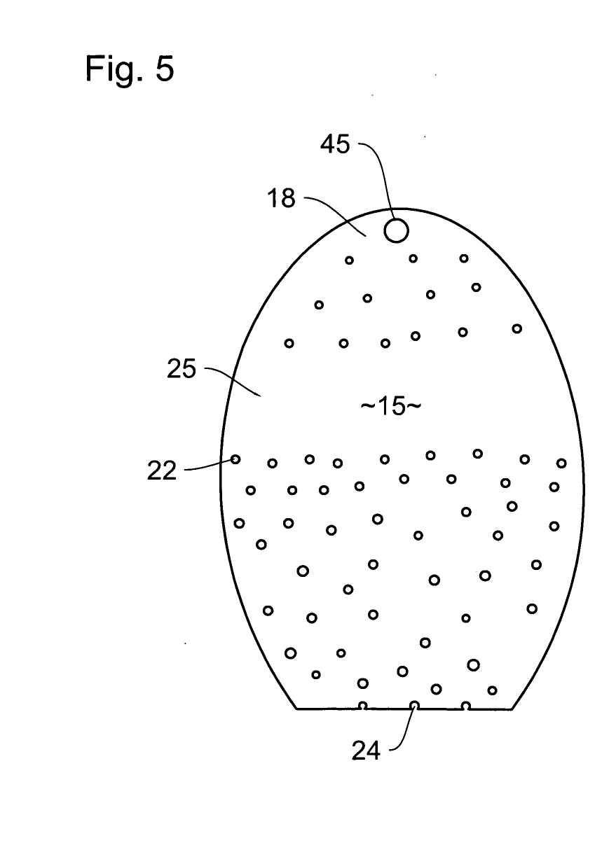

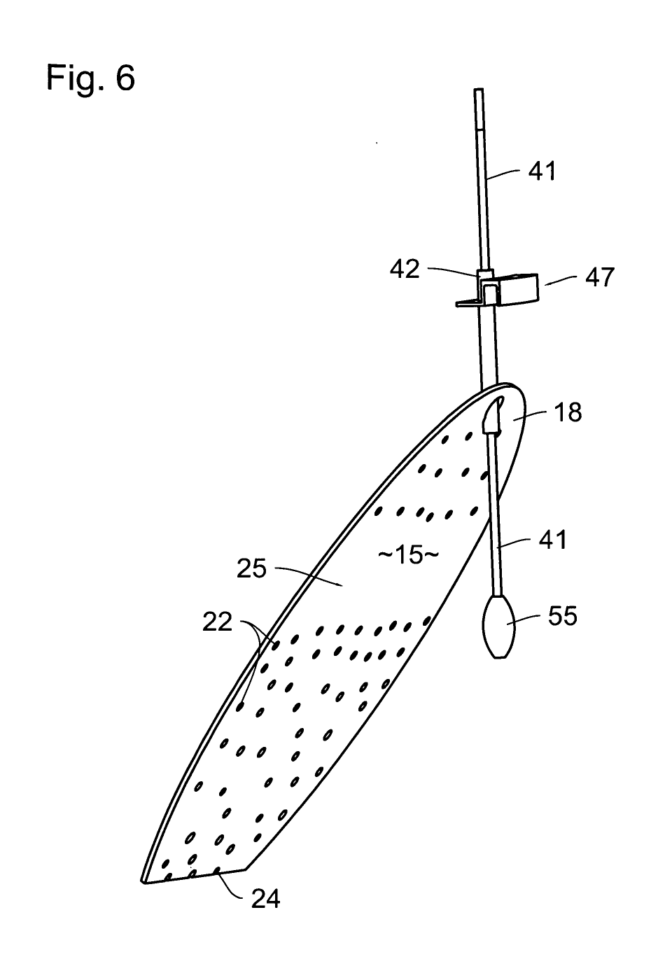

The perforated, generally planar baffle 15 is disposed at an angle within the pail 10. The plane of the baffle 15 theoretically intersects the pail body to form a conic section. Baffle 15 has numerous perforations 22 and 27 (FIGS. 2, 6) for water flow. Preferably baffle 15 is shaped generally like an ellipse, with a truncated bottom edge 24 that lies flatly on the planar flat bottom 26 of the pail 10 (i.e., FIG. 3). The arcuate, uppermost edge 28 of the baffle 15 is engaged by the water level float indicator 18 described below, that is mechanically reinforced by the baffle. It will be noted that an array of holes 22 is formed on the baffle top, and another array of holes 27 appears on the baffle bottom, with an intermediate spray deflection region 25 (FIGS. 5, 6) that has no holes. This region 25 will be contacted by water spray when a hose is inserted through hole 20 when refilling the pail to deflect and disperse water to aid the growing plants therewithin. The unperforated baffle region 25 dissipates the force of impact of inputted water.

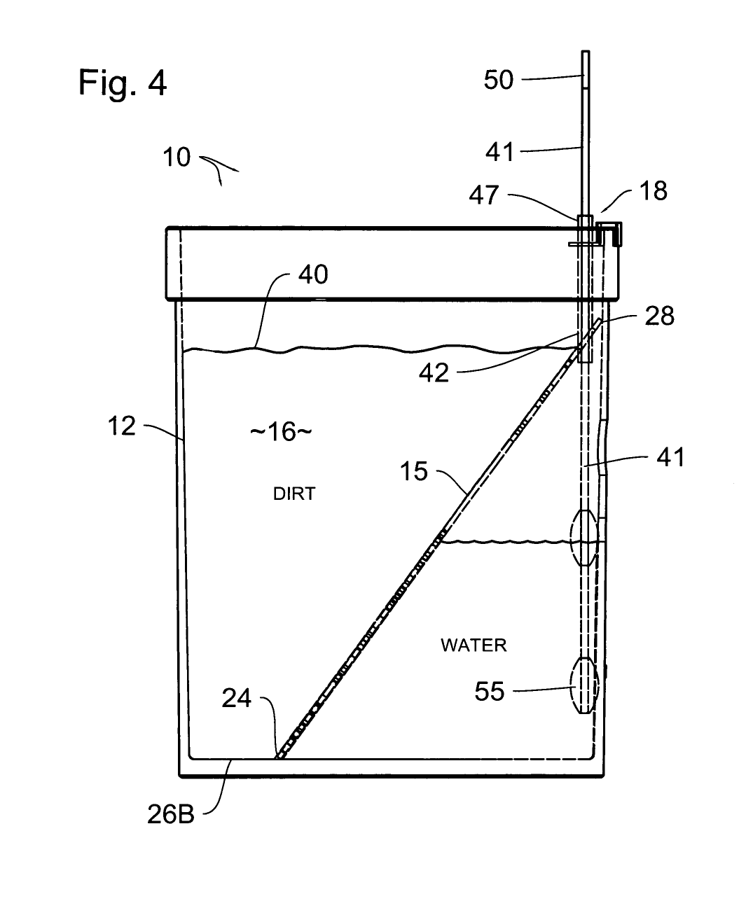

Viewing FIG. 4, the baffle 15 is seen disposed at an angle within interior 16 of the planter pot 10. The angle is designated by an arrow 29. Preferably the angle is between thirty and sixty degrees. In the best mode it is approximately forty to fifty degrees, with forty-five degrees preferred. The baffle bottom edge 24 lies upon the floor 26B (FIG. 4) of the pot bottom 26. The region to the right of the baffle is a liquid-filled volume 36 (FIG. 4) that is separated from concentrated dirt or soil by the baffle. Dirt and soil and plant material in growing volume 37 to the left of the baffle is wet, because of the water passing through the baffle perforations. The preferred water level 40 is maintained, especially if the weep hole 21 described above is utilized.

Referring primarily to FIG. 4, the water level float indicator 18 comprises an elongated shaft 41 supported by sleeve 42 that passes through a bracing orifice 45 defined in the baffle 15 (FIG. 5). Shaft 41 continues upwardly through sleeve 42 and bracket 47 that secures the float arrangement to the rim of the container 10, and terminates externally in a highly visible indicator 50. The shaft 41 has at least one float 55 (FIG. 4) located at its bottom for buoyancy. The height of indicator 50 is thus a direct indication of water level in volume 36 (FIG. 4).

From the foregoing, it will be seen that this invention is one well adapted to obtain all the ends and objects herein set forth, together with other advantages that are inherent to the structure.

It will be understood that certain features and subcombinations are of utility and may be employed without reference to other features and subcombinations. As many possible embodiments may be made of the invention without departing from the scope thereof, it is to be understood that all matter herein set forth or shown in the accompanying drawings is to be interpreted as illustrative and not in a limiting sense.

What is claimed is:

1. A planter comprising:
a pot comprising a lower base, a top, a peripheral exterior, and an interior bounded by said exterior;
a generally planar baffle that is disposed within the interior, the baffle dividing the interior to adjacent liquid volumes and growing volumes, the baffle comprising a plurality of perforations for allowing water flow between said liquid and growing volumes; and,
wherein the baffle is disposed at an angle within the pail and intersects the pail body to form a conic section.

2. The planter as defined in claim 1 wherein the base comprises a smaller diameter than the diameter of said top.

3. The planter as defined in claim 2 wherein the pot is in the form of a pail comprising a handle for carrying the pot.

4. The planter as defined in claim 1 further comprising an orifice defined in said pot for preventing overfilling with water.

5. The planter as defined in claim 4 further comprising a weep hole defined in said pot beneath said overfill orifice for establishing an initial fill line, and a plug for selectively blocking said weep hole.

6. The planter as defined in claim 1 wherein the baffle is shaped generally like an ellipse, and comprises a truncated bottom edge that lies flatly on the base of said pail.

7. The planter as defined in claim 6 wherein the perforated baffle comprises a first array of holes formed generally on the baffle top, a second array of holes formed generally beneath the first array of holes, and a non-perforated intermediate spray deflection region defined between said first and second array of holes.

8. The planter as defined in claim 1 wherein the baffle is disposed at an angle between thirty and sixty degrees.

9. The planter as defined in claim 8 wherein the baffle is disposed at an angle of between forty and fifty degrees.

10. The planter as defined in claim 9 wherein the baffle is disposed at an angle of approximately forty-five degrees.

11. The planter as defined in claim 1 further comprising a water level float indicator comprising an elongated shaft braced by in the baffle, a bracket on the pail that secures the float indicator, at least one float disposed within the pail, and a highly visible indicator driven by said shaft for indicating water level.

12. A planter comprising;
a pail comprising a lower base, a top, a peripheral exterior, an interior bounded by said exterior, and a carrying handle;
at least one orifice defined in said pail through said exterior for preventing overfilling;
a generally planar baffle that is disposed within the pail interior for dividing the pail interior to adjacent liquid volumes and growing volumes, the baffle comprising a plurality of perforations for allowing water flow between said liquid and growing volumes;
wherein the baffle is disposed at an angle within the pail of between forty and fifty degrees and intersects the pail body to form a conic section, the baffle shaped generally like an ellipse, and comprising a truncated bottom edge that lies flatly on the base of said pail.

13. The planter as defined in claim 12 wherein the perforated baffle comprises a first array of holes formed generally on the baffle top, a second array of holes formed generally beneath the first array of holes, and a non-perforated intermediate spray deflection region defined between said first and second array of holes.

14. The planter as defined in claim 13 further comprising a water level float indicator comprising an elongated shaft braced by the baffle, a bracket on the pail that secures the float indicator, at least one float disposed within the pail, and a highly visible indicator driven by said shaft for indicating water level.

15. The planter as defined in claim 12 further comprising a weep hole defined in said pail beneath said overfill orifice for establishing an initial fill line, and a plug for selectively blocking said weep hole.

16. A planter comprising;
a pail comprising a lower base, a top, a peripheral exterior, an interior bounded by said exterior, and a carrying handle;
at least one orifice defined in said pail through said exterior for preventing overfilling;
a generally planar baffle that is disposed within the interior, the baffle dividing the interior to adjacent liquid volumes and growing volumes, the baffle comprising a plurality of perforations for allowing water flow between said liquid and growing volumes;
wherein the baffle is disposed at an angle within the pail of approximately forty-five degrees and intersects the pail body to form a conic section, the baffle shaped generally like an ellipse, and comprising a truncated bottom edge that lies flatly on the base of said pail.

17. The planter as defined in claim 16 wherein the perforated baffle comprises a first array of holes formed generally on the baffle top, a second array of holes formed generally beneath the first array of holes, and a non-perforated intermediate spray deflection region defined between said first and second array of holes.

18. The planter as defined in claim 17 further comprising a water level float indicator comprising an elongated shaft braced by an orifice defined in the baffle, a bracket on the pail that secures the float indicator, at least one float disposed within the pail, and a highly visible indicator driven by said shaft for indicating water level.

19. The planter as defined in claim 18 further comprising a weep hole defined in said pail beneath said overfill orifice for establishing an initial fill line, and a plug for selectively blocking said weep hole.
